(19) United States
(12) Patent Application Publication
(10) Pub. No.: US 2026/0269093 A1
(43) Pub. Date: Sep. 10, 2026

(54) COOLED HEADSPACE UTILIZING NITROGEN-TO-NITROGEN HEAT EXCHANGER

(71) Applicant: Natura Resources LLC, Abilene, TX (US)

(72) Inventors: Alton Reich, Abilene, TX (US); Thomas Provencher, Abilene, TX (US); Rick Lanning, Abilene, TX (US)

(21) Appl. No.: 19/557,352

(22) Filed: Mar. 5, 2026

Related U.S. Application Data
(60) Provisional application No. 63/767,338, filed on Mar. 5, 2025.

(51) Int. Cl. G21C 15/14; G21C 1/02; G21C 11/08; G21C 15/28

(52) U.S. Cl. CPC G21C 15/14; G21C 1/02; G21C 11/08; G21C 15/28

(57) ABSTRACT

A molten salt reactor system includes a reactor vessel that defines a headspace and a reactor space. The reactor space may cause the headspace to increase in temperature. It may be desirable to provide certain temperature sensitive equipment within the headspace of the reactor enclosure. The forced convection heat removal system of the present disclosure may be employed to forcibly remove heat from the headspace, thereby providing a cool environment for the temperature sensitive equipment to properly function. The forced convection heat removal system may include a nitrogen-to-nitrogen heat exchanger disposed within the headspace, fluidly coupled to an external cooling system, and operable to cool an inert gas of the headspace.

### CROSS REFERENCE TO RELATED APPLICATIONS

This application relates and claims priority to U.S. Provisional Application No. 63/767,338, filed Mar. 5, 2025, and entitled “COOLED HEADSPACE UTILIZING NITROGEN-TO-NITROGEN HEAT EXCHANGER,” which is hereby incorporated by reference in its entirety.

### TECHNICAL FIELD

The described examples relate generally to systems, devices, and techniques for cooling a headspace of a nuclear reactor system.

### BACKGROUND

Molten salt reactors (MSR) maintain fuel salt at an elevated temperature to keep the salt in a molten phase. Previous iterations of MSRs, such as the Molten Salt Reactor Experiment as Oak Ridge National Laboratory, utilized heaters attached to various insulated components and piping to keep them at an elevated temperature sufficient to melt the fuel salt. Modern MSR systems may employ a different approach for ensuring the fuel salt stay molten. Such approaches may involve employing a reactor enclosure that encloses many or all fuel salt bearing components and forming an insulated oven heated to the requisite temperature for operating the MSR system. In many cases, it is desirable to include certain types of electronics, such as those used in instrumentation and control, which are sensitive to elevated temperatures, within or proximal to the MSR system. Such temperature sensitive electronics may be damaged or otherwise function improperly when positioned within or near the insulated oven of the reactor enclosure. As such, there is a need for systems and techniques to facilitate cooling of a space dedicated to housing such temperature sensitive electronics.

### SUMMARY

In one example, a system is disclosed. The system includes a system enclosure including a headspace and a reactor space. The system further includes a molten salt reactor vessel including a reactor core configured to facilitate fission reaction disposed within the reactor space. The system further includes a thermal insulation layer arranged about the molten salt reactor vessel and separating the reactor space from the headspace. The thermal insulation layer is operable to maintain a temperature of the molten salt reactor vessel. The system further includes a plurality of temperature sensitive equipment disposed within the headspace and including at least one functional component extending into the reactor space, the at least one functional component operably coupled with the molten salt reactor vessel. The system further includes a forced convection heat removal system configured to remove heat from the headspace thereby reducing a temperature of the headspace proximal the plurality of temperature sensitive equipment, wherein the forced convection heat removal system includes at least one nitrogen-to-nitrogen heat exchanger configured to cool an environment within the headspace by circulating a gas through the at least one nitrogen-to-nitrogen heat exchanger.

In another example, the reactor enclosure includes a radiation shielding layer surrounding the thermal insulation layer surrounding the reactor vessel surrounding the reactor core.

In another example, the headspace is filled with an inert gas at below atmospheric pressure.

In another example, the inert gas is nitrogen gas and the at least one nitrogen-to-nitrogen heat exchanger includes a cooling coil fill with nitrogen gas.

In another example, the plurality of temperature sensitive equipment includes at least one sensor connected to at least one probe. The at least one sensor is disposed within the headspace and the at least one probe is disposed within the reactor space.

In another example, the headspace includes at least one penetrating component operable to functionally link the at least one probe to the at least one sensor.

In another example, the plurality of temperature sensitive equipment includes equipment rated for a temperature lower than a temperature of the reactor space.

In another example, the system enclosure further includes a reactor access vessel, a drain tank, a pump, and a primary heat exchanger.

In another example, the system enclosure further includes a molten salt loop operable to continuously circulate a molten fuel salt through the reactor access vessel, the reactor core, and the primary heat exchanger, wherein the molten salt loop is circulated by the pump.

In another example, the temperature sensitive equipment includes the pump, the primary heat exchanger is disposed within the reactor space, and the pump is functionally coupled to the primary heat exchanger by at least one penetrating component.

In another example, the temperature of the reactor space is about 600° C.

In another example, the thermal insulation layer defines a thermal insulation region operable to maintain a temperature sufficient to melt a fuel salt.

In another example, a forced convection heat removal system coupled to a molten salt reactor enclosure is disclosed. The forced convection heat removal system includes at least one gas-to-gas heat exchanger positioned within a headspace of the reactor enclosure. The at least one gas-to-gas heat exchanger includes at least one fan, and a cooling coil configured to circulate a nitrogen gas of the headspace through the heat exchanger thereby cooling the nitrogen gas of the headspace. The cooling coil includes nitrogen gas. The forced convection heat removal system further includes a liquid-to-gas heat exchanger positioned outside the reactor enclosure. The liquid-to-gas heat exchanger is configured to cool the nitrogen gas of the cooling coil. The forced convection heat removal system further includes a chiller loop coupling the at least one gas-to-gas heat exchanger to the liquid-to-gas heat exchanger thereby facilitating removal of heat from the headspace.

In another example, the reactor enclosure further includes a reactor space positioned below the headspace.

In another example, the reactor enclosure includes a radiation shielding layer surrounding a thermal insulation layer surrounding a reactor vessel.

In another example, the thermal insulation layer separates the reactor space from the headspace.

In another example, a plurality of temperature sensitive equipment is disposed within the headspace and includes at least one functional component extending into the reactor space, the at least one functional component operably coupled with the reactor vessel.

In another example, the headspace includes the nitrogen gas under vacuum.

In another example, the forced convection heat removal system further includes two gas-to-gas heat exchangers.

In another example, the two gas-to-gas heat exchangers are operable to remove about 0.00341 MMBTU/hr from the headspace.

In another example, the reactor vessel houses a reactor core, a molten salt loop, and a primary heat exchanger collectively operable to facilitate power generation through fission reaction within the reactor core.

In another example, a method for maintaining a temperature of a headspace of a molten salt reactor system is disclosed. The method includes operating the molten salt reactor system thereby heating a reactor enclosure. The method further includes providing an inert environment in the headspace of the reactor enclosure. The method further includes providing a forced convection heat removal system in the headspace of the reactor enclosure. The forced convection heat removal system includes at least one gas-to-gas heat exchanger positioned within the headspace and coupled, by a chiller loop, to a liquid-to-gas heat exchanger positioned outside the molten salt reactor system. The at least one gas-to-gas heat exchanger configured to remove heat from the headspace by transferring the heat to the liquid-to-gas heat exchanger. The method further includes removing heat from the headspace by operating the forced convection heat removal system.

In another example, the method further includes operating a plurality of temperature sensitive equipment in the headspace of the reactor enclosure.

### BRIEF DESCRIPTION OF THE DRAWINGS

FIG. 1 illustrates an example molten salt reactor system.

FIG. 2 illustrates a schematic diagram of an example forced convection heat removal system for a molten salt reactor system.

FIG. 3 illustrates an example reactor enclosure equipped with an example forced convection heat removal system.

FIG. 4 illustrates a headspace of the example reactor enclosure of FIG. 3.

FIG. 5 illustrates a transparent view of an example gas-to-gas heat exchanger.

FIG. 6 illustrates a flow diagram of an example method for maintaining a temperature of a headspace of a molten salt reactor system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes example systems, methods, and apparatuses that embody various elements of the present disclosure. However, it should be understood that the described disclosure may be practiced in a variety of forms in addition to those described herein.

The following disclosure relates generally to systems, devices, and methods for cooling a headspace of an MSR system. MSR systems require certain salt-bearing components (i.e., components making contact with molten salt) (e.g., reactor core, reactor access vessel, primary heat exchanger, piping therebetween, etc.) to be at an elevated temperature to ensure the fuel salt contained therein remains in a molten phase. The fuel salt may be a LiF—BeF₂—UF₄ composition, though other compositions of fuel salts may be utilized within the reactor system. The fuel salt may have a fissile material (e.g., uranium) dissolved therein configured to undergo fission reactions thereby generating thermal energy. The fuel salt must be elevated to about 600° C. to remain in a molten phase.

In many cases, it is desirable to include certain electronics to serve as instrumentation and control for the MSR system and components therein. As a nonlimiting example, the MSR system may require a pump to circulate the fuel salt throughout the molten salt loop of the MSR system. However, such a pump (and other equipment) may be inoperable, deteriorate, or otherwise malfunction at temperatures of about 600° C. Additionally, even if such elevated temperatures do not render certain electronics and equipment inoperable, it may impede their function and cause other associated inefficiencies (i.e., inaccuracy, reliability, life-expectancy, etc.). Conventional approaches may require temperature sensitive equipment to be located far from and outside of the reactor enclosure of the MSR system to ensure they do not overheat, but this may be undesirable for a variety of reasons (e.g., spatial constraints, edge computing, and construction feasibility). For example, temperature sensitive equipment may include pumps, level sensors, flowmeters, temperature probes, pressure transmitters, motors, valves, and other similar equipment. The equipment may be sensitive to temperature in that it may operate inefficiently, inaccurately, or otherwise fail completely at high temperatures. Such issues would have a drastic impact on the operations of the MSR system, which relies on data output of such equipment to ensure operational parameters are maintained.

To mitigate these and other challenges, the example cooling systems of the present disclosure may be coupled to a headspace of an MSR system housing the temperature sensitive equipment and operable to cool the environment of the headspace to a sufficient degree to maintain an acceptable temperature for the temperature sensitive equipment to function properly. Advantageously, this design allows the temperature sensitive equipment to be proximal to the reactor system while avoiding heat damage caused by such proximity. The cooling system may be operable to cool the headspace from rising heat emanating from the MSR system and/or generated by the insulated oven defined by the reactor enclosure. Moreover, the example cooling systems of the present disclosure are designed to cooperate with safety parameters of the MSR system. For example, many effective coolants, such as water, are neutron moderators and, if leaked, will disrupt the neutron characteristics of the reactor core of the nuclear system. Maintaining a low pressure within the headspace is advantageous as it enables detection of any leaks and, in case of such a leak, causes air to be sucked into the headspace rather than allowing potentially hazardous gaseous fission products to leak out of the headspace. While liquid coolants, such as liquid nitrogen, may be an effective heat carrier, if leaked, the liquid nitrogen will quickly evaporate and cause an increase in pressure in the system, which will compromise the vacuum within the headspace. The present disclosure anticipates these concerns and maintains these safety measures by providing gaseous nitrogen as the coolant. Gaseous nitrogen is not a neutron moderator and will only negligibly affect the pressure of the headspace in the event of a leak. Thus, utilization of gaseous nitrogen addresses various safety concerns present when introducing a coolant into the headspace of an MSR system. The headspace of the MSR system may include an inert gas environment, for example of nitrogen gas, and maintained at below atmospheric pressure (e.g., about 7 psia).

To facilitate the foregoing, the cooling system may be disposed within and coupled to an MSR system. The MSR system may include an insulating reactor enclosure defining an internal volume and operable to maintain a proper operating temperature (i.e., 600-700° C.) therein to ensure a molten phase of the fuel salt. The reactor enclosure may define a headspace and a reactor space. The reactor space may be configured to house various components of the MSR system, including but not limited to, a reactor vessel, a reactor core, a reactor access vessel, drain tank, a primary heat exchanger, and various piping therebetween (defining and referred to as a molten salt loop). The headspace may be configured to house various temperature sensitive equipment utilized for instrumentation and control. In at least one example, the temperature sensitive equipment may include a functional component or probe extending into the reactor space, such that the temperature sensitive equipment is operable to capture characteristics data from components within the reactor space. However, given that the reactor enclosure maintains an operational temperature of about 600-700° C. and the temperature sensitive equipment cannot operate at such a temperature (or may become defective when exposed to such temperature ranges), a cooling system or forced convection heat removal system may be employed to remove heat from the headspace region to keep the temperature at an acceptable range (at least below 600° C.) to avoid the sensitive equipment from failing, degrading, or otherwise malfunctioning.

To facilitate the foregoing, the cooling system of the present disclosure may include at least one nitrogen-to-nitrogen heat exchanger disposed within the headspace of the reactor enclosure. The nitrogen-to-nitrogen heat exchanger may be operable to remove heat from the headspace via heat transfer. The nitrogen-to-nitrogen heat exchanger may be fluidly connected to an external cooling system operable to export heat from within the headspace to outside the reactor enclosure, thereby cooling the headspace. In several embodiments, the nitrogen-to-nitrogen heat exchanger is configured to circulate and cool nitrogen gas within the headspace and transfer heat from the nitrogen gas of the headspace to another nitrogen gas of the heat exchanger. In one example, nitrogen gas of the headspace is circulated via an inlet fan and an outlet fan. The inlet fan and outlet fan may be positioned on opposite sides of a body of the heat exchanger housing heat transfer pipes or tubes. In one example, the nitrogen-to-nitrogen heat exchanger includes only a single fan. The heat exchanger may further include a cooling coil interposed between the inlet fan and outlet fan within the body of the heat exchanger and containing a secondary coolant (e.g., another nitrogen gas). The inlet fan, outlet fan, and cooling coil may be operable to cooperatively remove heat from within the headspace and transfer it to an external cooling system. In one example, the cooling system includes two nitrogen-to-nitrogen heat exchangers to sufficiently cool the headspace; however, more than two nitrogen-to-nitrogen heat exchangers may be employed based on the cooling needs. The two nitrogen-to-nitrogen heat exchangers may be coupled to an external liquid-to-nitrogen heat exchanger further coupled to a chiller collectively operable to expel heat from within the headspace to the atmosphere.

To facilitate the foregoing the nitrogen-to-nitrogen heat exchanger may be functionally coupled to a liquid-to-gas heat exchanger positioned outside the reactor enclosure via a penetrating element. The penetrating element may be configured to house piping and/or tubes configured to fluidically couple the coolant of the nitrogen-to-nitrogen heat exchanger to a liquid-to-gas heat exchanger or other mechanical linkages. The liquid-to-gas heat exchanger may be further coupled to a chiller including a chiller pump to expel the heat extracted. Thus, the nitrogen-to-nitrogen heat exchanger is configured to transfer the heat within the headspace to a coolant and expel the heat, via the coolant and the exterior liquid-to-gas heat exchanger, to an environment outside the reactor enclosure.

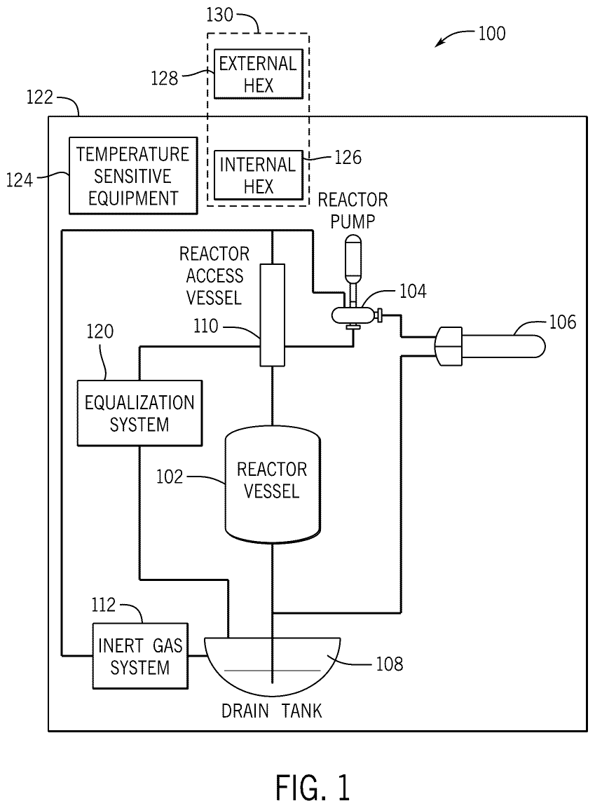

Turning now to the Drawings. FIG. 1 illustrates a schematic representation of an example molten salt reactor (MSR) system 100 to which the example cooling system 130 may be employed. In various embodiments, a molten salt reactor system 100 utilizes fuel salt with enriched uranium (e.g., high-assay low-enriched uranium) dissolved therein and configured to generate thermal power via nuclear fission reactions. In one example, the composition of the fuel salt is LiF—BeF₂—UF₄, though other compositions of fuel salts may be utilized as fuel salts within the reactor system 100 (e.g., chloride-based salts). The fuel salt within the system 100 is heated to high temperatures (about 600-700° C.) and melts as the system 100 is heated. In one example, the MSR system 100 is at least partially enclosed by a reactor enclosure 122. The reactor enclosure 122 may define an internal volume and operable to insulate heat therein, thereby forming a thermal oven within the internal volume to maintain a high temperature necessary to maintain a molten phase of the fuel salt (i.e., 600-700° C.). Advantageously, this configuration obviates the need for continuous heating from external heaters as the thermal oven maintains operational temperatures by insulating the thermal energy produced by the fission reactions. To facilitate the foregoing, the reactor enclosure 122 may include one or more insulating layers operable to insulate the components of the MSR system 100. The insulating layer effectively functions as an oven by insulating the heat produced via fission reaction within the reactor vessel 102 to maintain an operational temperature of the MSR system. In one example, MSR system 100 includes the systems, devices, and/or mechanisms disclosed in U.S. application Ser. No. 18/450,884, which is hereby incorporated by reference in its entirety. The molten salt reactor system 100 may further include a reactor vessel 102 where the fission reactions occur within the molten fuel salt, a fuel salt pump 104 that pumps the molten fuel salt to a primary heat exchanger 106, such that the molten fuel salt re-enters the reactor vessel 102 after flowing through the heat exchanger 106, and piping in between each component. The piping between each component facilitates circulations of the molten salt and may be collectively referred to as the molten salt loop. The MSR system 100 may also include additional components, such as, but not limited to, drain tank 108 and reactor access vessel 110. The drain tank 108 may be configured to store the fuel salt once the fuel salt is in the reactor system 100 but in a subcritical state and act as storage for the fuel salt if power is lost in the system 100. The reactor access vessel 110 may be configured to allow for introduction of small pellets of uranium fluoride (UF₄) to the system 100 as necessary to bring the reactor to a critical state and compensate for depletion of fissile material.

In several examples, the molten salt reactor system 100 includes an inert gas system 112 to provide inert gas (e.g., nitrogen) to a head space of the drain tank 108, among other functions. The inert gas system 112 may further relieve inert gas from the head space of the drain tank 108 as needed. The inert gas system 112 is therefore operable to maintain pressurized inert gas in the headspace of the drain tank 108 that is sufficient to substantially prevent the flow of molten fuel salt into the drain tank during normal operations. The inert gas system 112 may be operable to maintain a pressure below atmospheric pressure within the headspace. For example, with the head space of the drain tank 108 pressurized by the inert gas system 112, molten salt may generally circulate between the reactor vessel 102 and the primary heat exchanger 106 without substantially draining into the drain tank 108. In some cases, the inert gas system 112 may be configured to supply inert gas to the headspace of various other components of the molten salt reactor system 100, such as to the headspace of the reactor access vessel 110, to the seal of reactor pump 104, among other components. Upon the occurrence of a shutdown event, the inert gas system 112 may cease providing inert gas to the head space of the drain tank 108, and other components to which the system 112 supplies inert gas.

The molten salt reactor system 100 may further include an equalization system 120 that is operable to equalize the pressure between the headspace of the drain tank 108 and the reactor vessel 102 upon the occurrence of a shutdown event. For example, during normal operation a pressure differential exists between the headspace of the drain tank 108 and the reactor vessel 102. Such pressure differential prevents or impedes the draining of the fuel salt into the drain tank 108. In this regard, the equalization system 120 may be operable to fluidically couple (via opening one or more valves) the head space of the drain tank 108 and the reactor vessel 102 to reduce or eliminate the pressure differential, thereby allowing the fuel salt to readily flow into the drain tank upon the shutdown event.

The molten salt reactor system 100 may further include or otherwise be coupled to a cooling system 130 at least partially disposed within the reactor enclosure 122 and operable to cool at least a portion of the reactor enclosure 122 (e.g., the headspace). The cooled area may be occupied by temperature sensitive equipment 124 operable for instrumentation and control operation, which may be graded for a temperature below that of the reactor enclosure 122 (i.e., 600-700° C.). The cooling system 130 may include at least one internal heat exchanger 126 disposed within the reactor enclosure 122 and at least one external heat exchanger 128 disposed outside the reactor enclosure 122. The internal heat exchanger 126 and external heat exchanger 128 are collectively operable to remove heat from within the reactor enclosure 122 and export it outside the reactor enclosure 122. Advantageously, the cooling system 130 is operable to cool a portion of the reactor enclosure 122 housing the temperature sensitive equipment 124, such that they may operate despite their proximity to the heated components of the MSR system 100 and their position within the thermal oven.

It will be appreciated that the systems, devices, methods for cooling a headspace may be used to cool the environment of one or more tanks or vessels described above in relation to the MSR system 100. In one example, the cooling systems described herein may be used to cool the environment of the reactor access vessel 110, the reactor vessel 102, the drain tank 108 and/or other various MSR components. In other cases, the cooling systems described herein may be configured to control a temperature in other vessels or tanks of the MSR system 100 and/or of other nuclear reactor systems. In this regard, the molten salt reactor system 100 is presented for purposes of illustration, and the example systems, devices, and methods described herein have wide applicability for use in cooling spaces in various vessels, tanks, and spaces defined therein of a molten salt reactor system or other reactor systems.

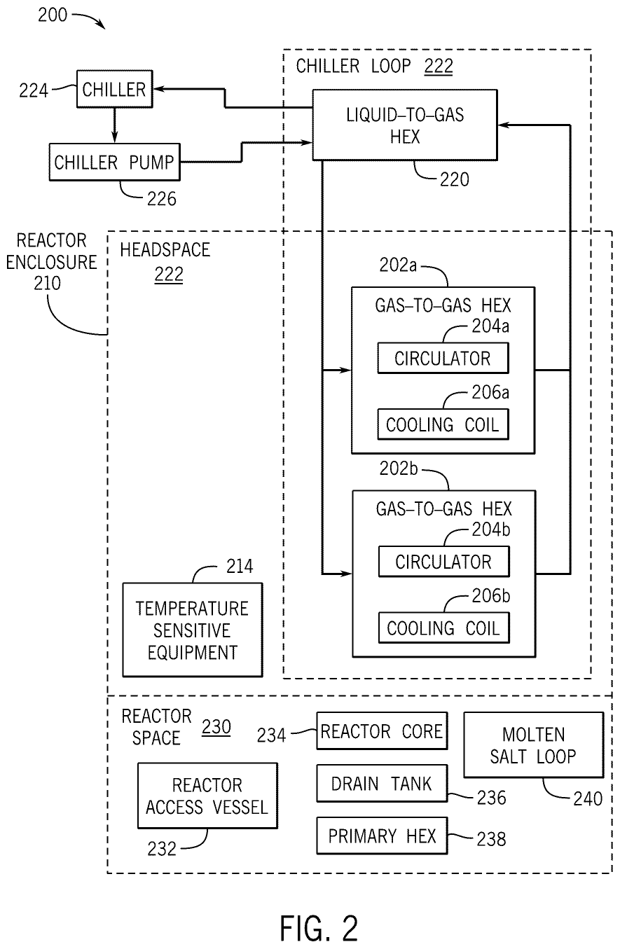

FIG. 2 illustrates an example forced convection heat removal system 200 for an MSR system (e.g., MSR system 100). For example, the force heat removal system 200 may be used to cool the headspace of reactor enclosure 122 of the reactor system 100.

The reactor enclosure 210 may be a vessel housing the components of MSR system 100. The reactor enclosure 210 may be a cylindrical stainless-steel vessel. The reactor enclosure 210 may provide thermal insulation and radiation shielding for the MSR system 100. The reactor enclosure 210 may include and/or define a headspace 212 and a reactor space 230. The headspace 212 may be positioned above the reactor space 230. The reactor enclosure 210 may enclose the reactor space 230 with a thermal insulation layer and a radiation shielding layer while the headspace 212 may be outside but proximal to the thermal insulation layer and radiation shielding layer. However, in at least one example, the headspace 212 is disposed within the thermal oven defined by reactor enclosure 210. Reactor enclosure 210 may include liners or layers operable to provide thermal insulation and radiation shielding and may only be partially lined with such layers. The thermal insulation layer and/or radiation shielding layer may separate the headspace 212 from the reactor space 230. Despite being thermally insulated, heat within the reactor space 230 may rise and heat the headspace 212. The headspace 212 may include at least a portion of the chiller loop 222 and may further include a plurality of temperature sensitive equipment 214. The plurality of temperature sensitive equipment 214 and at least a portion of the chiller loop 222 may be disposed within a region of the reactor enclosure 210 defined as the headspace 212. The temperature sensitive equipment 214 may include a wide variety of sensors, monitors, indicators, devices (mechanical or electrical) or other components graded at a temperature lower than that of the reactor space 230 and operable to instrumentation and control functions. For example, the temperature sensitive equipment 214 may include a pump, temperature sensor, and/or a level sensor. Such temperature sensitive equipment 214 may become inoperable, inaccurate, or even deteriorate at the operating temperatures of an MSR system (i.e., 600-700° C.). The reactor space 230 may include a reactor access vessel 232, a reactor core 234, a drain tank 236, a primary heat exchanger 238, and a molten salt loop 240. These components may be substantially analogous to those described with reference to FIG. 1 (e.g., reactor access vessel 102, reactor vessel or core 102, drain tank 108, and primary heat exchanger 106). Stated otherwise, the various reactor components (e.g., reactor access vessel 232, reactor core 234, a drain tank 236, primary heat exchanger 238, and molten salt loop 240) may be disposed within a region of the reactor enclosure 210 defined as the reactor space 230. For clarity, this region is referred to as the reactor space 230 due to it being a region where certain functional components of the MSR system are placed. For example, the reactor space 130 includes the reactor core 234 operable to facilitate fission reactions necessary for power production to take place. One of ordinary skill in the art will appreciate the meaning of headspace and reactor space and understand how they relate to a nuclear reactor system. The reactor space 230 is heated to a temperature of about 600-700° C. (via external heaters and maintained via fission reaction) and may transfer heat to the headspace 212.

The forced convection heat removal system 200 may include a first gas-to-gas heat exchanger 202a and a second gas-to-gas heat exchanger 202b, each including a circulator 204a, 204b, and a cooling coil 206a, 206b. While FIG. 2 illustrates a first gas-to-gas heat exchanger 202a and a second gas-to-gas heat exchanger 202b, the forced convection heat removal system 200 may include only one gas-to-gas heat exchanger or may include more than two gas-to-gas heat exchangers based on the cooling needs. The gas-to-gas heat exchangers 202a, 202b may be disposed with a headspace 212 of a reactor enclosure 210. In one example, the gas-to-gas heat exchangers 202a, 202b are operable to remove about 0.00341 MMBTU per hour from the headspace 212 during operation. In one example, the headspace 212 is filled with nitrogen gas defining an inert environment. The circulators 204a, 204b may be operable to circulate the inert gas of the headspace 212 over the cooling coil 206a, 206b, thereby cooling the inert gas of headspace 212 via heat transfer with a coolant within cooling coils 206a, 206b. For example, the circulators 204a, 204b may include an inlet fan and/or an outlet fan positioned on opposite ends of the gas-to-gas heat exchangers 202a, 202b, such that the inert gas of the headspace 212 may be passed through the heat exchangers 202a, 202b from one end to another by the inlet fan drawing in the inert gas and/or the outlet fan drawing out the inert gas. In one example, the cooling coils 206a, 206b, are coils composed of high conductive material that include some diameter to enable passage of a coolant therethrough and may be coiled within a body of the heat exchangers 202a, 202b, thereby defining a passage interior to the coil for the inert gas to flow through by the circulators 204a, 204b.

In one example, the coolant within the cooling coils 206a, 206b is nitrogen gas. This is advantageous for various reasons. For example, while water may be a more efficient coolant, leakage may cause the neutron moderating water to disrupt the neutron characteristics of the MSR system. As another example, leakage of a liquid coolant (e.g., water or liquid nitrogen) is likely to quickly evaporate within the headspace, causing a pressure increase. The cooling coils 206a, 206b may be fluidly coupled to a liquid-to-gas heat exchanger 220 via tubing or piping and collectively define a chiller loop 222. The liquid-to-gas heat exchanger 220 may be generally operable to cool the coolant of the cooling coils 206a, 206b and circulate it back to the gas-to-gas heat exchangers 202a, 202b, thereby facilitating removal of heat from the headspace 212. The liquid-to-gas heat exchanger 220, may be positioned exterior to the reactor enclosure. The liquid of the liquid-to-gas heat exchanger 220 may be water or other suitable liquid coolant and may be disposed within tubing or piping connecting the liquid-to-gas heat exchanger 220 to a chiller 224. The chiller 224 may be generally operable to expel the heat from the liquid coolant of the liquid-to-gas heat exchanger. The chiller 224 may include or be functionally coupled to a chiller pump 226 operable to power the circulation of the coolant between the chiller 224 and the liquid-to-gas heat exchanger 220. The cooling system 200 may further include other components not specifically illustrated herein to facilitate cooling of the headspace. For example, the cooling system 200 may further include fans, pumps, circulators, compressors, valves, bypasses, exhaust fans, radiators, and piping or tubing therebetween. Thus, the gas-to-gas heat exchangers 202a, 202b, liquid-to-gas heat exchanger 220, and chiller 224 may collectively operate to cool an environment of the headspace 212 by forcibly removing heat therein. Advantageously, by forcibly removing heat from the headspace 212, the temperature sensitive equipment 214 may be enabled to function or may otherwise eliminate or lessen any undesirable effects of operation in a high temperature environment (e.g., wear and tear, inaccuracies, etc.) while being proximal to the MSR system.

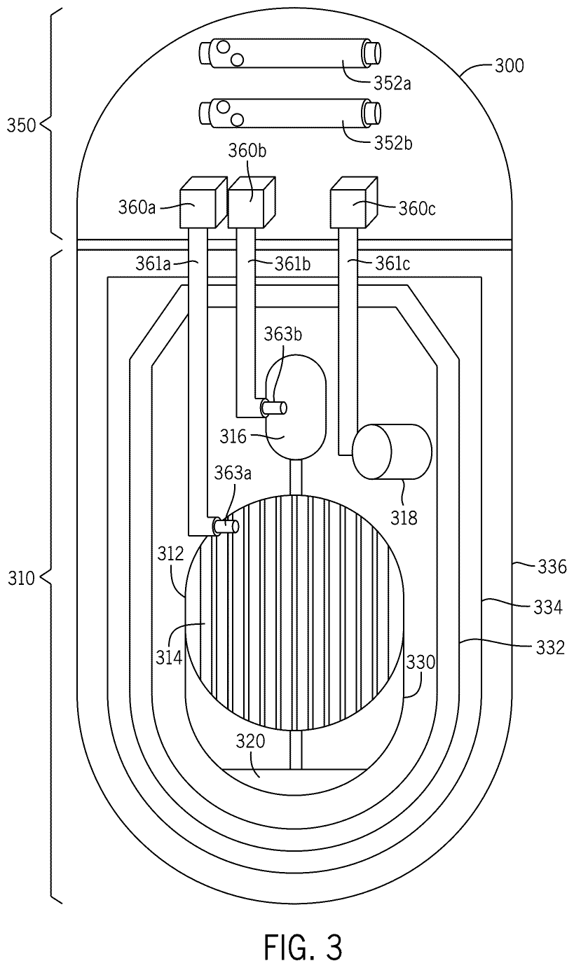

FIG. 3 illustrates an example reactor enclosure 300 of a MSR system (e.g., MSR system 100). The reactor enclosure 300 may be a vessel encompassing components of an MSR. The reactor enclosure 300 may include and/or define a headspace 350 and a reactor space 310. The reactor space 310 may include a variety of functional components of an MSR system. For example, the reactor space 310 may include a reactor core 312 including a graphite moderator 314, a reactor access vessel 316, a primary heat exchanger 318, a drain tank 320, and piping therebetween. However, one of ordinary skill in the art will appreciate that the reactor space, and the MSR system as a whole, may include a wide variety of nuclear reactor components not specifically listed herein and that such components are contemplated by the present disclosure. Such components may be heated to an elevated temperature, for example at about 600-700° C., to ensure the fuel salt therein is maintained at a molten phase. Heating may be initially applied by external heaters and maintained via fission reaction occurring with the reactor core 312. The reactor enclosure 310 may include various insulating means to maintain the operating temperature.

The reactor space 310 may include a reactor shell or reactor vessel 330, a thermal insulation layer 332, and a radiation shielding layer 336. The reactor vessel 330 may be enclosed by the insulation layer 332, which may be enclosed by the radiation shielding layer 336. The reactor space 310 may further include a gap 334 between the insulation layer 332 and the radiation shielding layer 336. In many embodiments, the reactor space 310 and the headspace 350 are separated by the thermal insulation layer 332 and the radiation shielding layer 336. In several embodiments, the thermal insulation layer 332 defines an insulation region and is operable to maintain a temperature sufficient to melt a fuel salt (e.g., about 600-700° C.). The thermal insulation layer 332 may generally comprise a thermally insulating material able to withstand a high radiation environment, including but not limited to a kaowool material, a mineral wool material, or other similar material known in the art. In several embodiments, the gap 334 may impart thermal insulating properties by including an inert gas under partial vacuum. The inert gas of the gap 334 may include nitrogen or any other inert gas. The radiation shielding layer 336 may be generally operable to shield the environment external to the reactor enclosure 330 from radiation produced by the MSR system contained therein. The radiation shielding layer 335 may generally comprise a radiation shielding, gamma shielding, and/or neutron shielding material, including but not limited to lead, concrete, borated polyethylene, boron carbide, and/or stainless steel. Notably, while the thermal insulating layer 332 and gap 334 may be operable to insulate the components enclosed therein, heat from the MSR system is likely to rise to the headspace 350 and consequently cause the headspace to require cooling.

The headspace 350 may include an inert gas environment and may be maintained at a pressure below atmospheric pressure. For example, the inert gas environment may include nitrogen gas, and the pressure may be about 7 psia. The headspace 350 may include at least a portion of the cooling system (e.g., cooling system 200). For example, the headspace may include a first heat exchanger 352a and a second heat exchanger 352b. The heat exchangers 352a, 352b may be substantial analogous to those described with reference to FIG. 2 and may each include a circulator component, a cooling coil, and may be fluidly coupled to an external heat exchanger. The heat exchangers 352a, 352b may be generally operable to cool the headspace 350 by transferring heat from the inert gas of the environment of the headspace 350 to a coolant. The heat exchangers 352a, 352b may be fluidly coupled to an exterior heat exchanger (e.g., liquid-to-gas heat exchanger 220) via a coupling assembly defining a passage for the coolant gas to exit the headspace 350. The coupling assembly may be a penetrating element, weld neck flange, or other penetrating means known in the art. The coupling assembly may allow tubing, piping, or mechanical linkages of the cooling system to exit the headspace 350 while being operable to maintain a pressure and/or airtight seal. In several embodiments, the coupling assembly is configured to enable passage of coolant piping of the heat exchangers 352a, 352b to the liquid-to-gas heat exchanger 220.

The headspace 350 may further include a plurality of temperature sensitive equipment. The plurality of temperature sensitive equipment may be sensitive to elevated temperature present in or proximal to MSR systems and may experience performance loss, deterioration, or inaccuracy when exposed to such elevated temperatures. However, MSR systems (e.g., MSR system 100) that employ an insulating reactor enclosure to heat the various components therein, still require certain temperature sensitive equipment to ensure operations function properly. For example, the MSR system may require a pump, various pressure and temperature sensors, neutron detectors, fluid level sensors and other equipment associated with nuclear reactor operations. Additionally, it may be advantageous or necessary to keep such temperature sensitive equipment in close proximity to the MSR system such that the equipment provides accurate, quick, and reliable data. As such, the present invention contemplates providing a forced convection heat removal system to cool an area of the reactor system housing such equipment, advantageously allowing the equipment to function properly while enabling close proximity to the components being monitored.

The temperature sensitive equipment cooled by the example cooling systems of the present disclosure may include a wide variety of electronic devices or mechanical devices graded for a temperature below that of the MSR system (i.e., around 600-700° C.). The plurality of temperature sensitive equipment may be any number of components utilized for instrumentation and control for an MSR system. For example, the plurality of temperature sensitive equipment illustrated in FIG. 3 includes a temperature monitor 360a, a level monitor 360b, and a pump 360c. While FIG. 3 illustrates certain example temperature sensitive equipment, one of ordinary skill in the art will appreciate that the cooled headspace and associated cooling system may be operable to cool any number of temperature sensitive electronic devices or mechanical devices used in nuclear operations. The temperature monitor 360a, the level monitor 360b, and the pump 360c may be graded for a temperature below that of the reactor area 310 (e.g., about 600-700° C.) and may deteriorate or otherwise malfunction if exposed to such high temperatures. In one example, the temperature sensitive equipment 360a, 360b includes a sensing component for data processing and a probe component for data collection. The temperature monitor 360a includes a probe 363a coupled to the reactor core 312 by coupling 361a. The level monitor 360b includes a probe 363a coupled to the reactor access vessel 316 by coupling 361b. The pump 360c is coupled to the primary heat exchanger 318 by tubing or piping 365. While the sensor component may be disposed within the headspace 350, the probe component may be disposed within the reactor space 310 and may be connected to the sensor component via tubing, piping, or other mechanical linkage. As illustrated in FIG. 3 each temperature sensitive equipment may include a coupling component that extends from the headspace 350 into the reactor space 310. For example, the temperature monitor 360a (i.e., the sensing component) includes coupling 361a which extends to the reactor core 312; the level sensor 360b (i.e., the sensing component) includes coupling 361b which extends to the reactor access vessel 316; and pump 360c includes tubing or piping 365 which extends to the primary heat exchanger 318. Coupling components 361a, 361b, 365, may include additional components such as flanges, bolts, seals, and valves to facilitate coupling into the reactor space 310 while maintaining an airtight, watertight, or hermetic seal therein. FIG. 3 illustrates probe components (e.g., 363a, 363b) as each being coupled to or extending into a component of the reactor space 310. For example, probe component 363a is illustrated as being coupled to the reactor core 312 and probe component 363b is illustrated as being coupled to the reactor access vessel 316. As such, probe component 363a is configured to measure a temperature of the reactor core 312 and probe component 363b is configured to measure a fluid level of the reactor access vessel 316. However, not all temperature sensitive equipment contemplated herein includes a probe component. For example, pump 360c includes tubing or piping 365 (i.e., coupling component) functionally connecting pump 360c to primary heat exchanger 318, such that molten salt may be circulated therethrough. One of ordinary skill in the art will appreciate that FIG. 3 illustrates merely one example of sensor components and probe components and that such temperature sensitive equipment 360a, 360b, 360c may be functionally connected to any reactor component depending on the need.

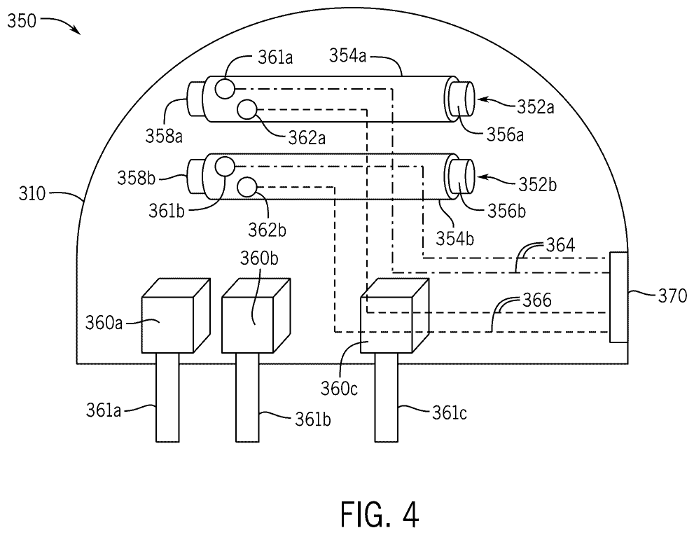

FIG. 4 illustrates the headspace 350 of the example reactor enclosure 300 of FIG. 3. FIG. 4 illustrates a more detailed view of the components of the cooling system disposed within the headspace 350. As previously discussed, the reactor space 310 of the reactor enclosure 300 is at an elevated temperature and likely to leak heat to the headspace 350, which needs to be cooled in order to maintain an acceptable operating range (e.g., less than 700° C.) to avoid damage to temperature sensitive equipment 360a, 360b, 360c disposed within the headspace 350. In order to maintain such an acceptable temperature, the headspace 350 may employ a cooling system operable to forcibly remove heat from the headspace 350. The heat exchangers 352a, 352b may be generally operable to circulate the nitrogen gas within the headspace 350 and through bodies 354a, 354b where heat is transferred to a coolant. The coolant may flow into and out of the reactor enclosure 310 through dedicated piping to a liquid to nitrogen heat exchanger outside the reactor enclosure (e.g., liquid-to-gas heat exchanger 220) where the coolant will be chilled to expel the heat removed from the headspace 350. To facilitate the foregoing, the headspace may include a first heat exchanger 352a and a second heat exchanger 352b. In several embodiments, the heat exchangers 352a, 352b are nitrogen-to-nitrogen heat exchanges. The heat exchangers 352a, 352b are configured to cool a nitrogen gas environment of the headspace 350 by transferring heat from said nitrogen gas to a coolant circulated within the heat exchangers 352a, 352b. In several embodiments, the coolant is nitrogen gas and fluidly coupled to an external heat exchanger, for example, the liquid-to-gas heat exchanger 220 of FIG. 2.

In several examples, each heat exchanger 352a, 352b includes a body 354a, 354b, an inlet fan 356a, 356b, an outlet fan 358a, 358b, a coolant inlet 361a, 361b, and a coolant outlet 362a, 362b. In several embodiments, the inlet fans 356a, 356b and outlet fans 358a, 358b are collectively operable to circulate a nitrogen gas of the headspace through bodies 354a, 354b, thereby cooling the headspace by bathing the circulating nitrogen gas over a cooling coil contained within bodies 354a, 354b. Such cooling may enable the plurality of temperature sensitive equipment 360a, 360b, 360c to operate efficiently. In several embodiments, the inlet fans 356a, 356b, and outlet fans 358a, 358b may also be graded for temperatures below that of the reactor space 310. As previously discussed, the heat exchangers 352a, 352b may be fluidly coupled to an external cooling system (e.g., liquid-to-gas heat exchanger 220 of FIG. 2). In several embodiments, such fluid coupling is facilitated by tubing or piping connecting coolant inlets 361a, 361b and coolant outlets 362a, 362b to the liquid-to-gas heat exchanger 220. In several embodiments, the cooling system includes coolant inlet pipes 364 and coolant outlet pipes 366 collectively operable to circulate the coolant into and out of the heat exchangers 352a, 352b.

In example, the headspace includes a penetrating element 370 operable to allow the coolant inlet pipes 364 and coolant outlet pipes 366 from exiting the headspace 350, consequently enabling the heated coolant (from coolant outlets 362a, 362b) from exiting the headspace 350 and enabling the cooled coolant (to coolant inlet 361a, 361b) to enter the headspace 350. In one example, the penetrating element 370 includes a plurality of ports to accommodate piping 364, 366. Penetrating element 370 may further include a single port configured to accommodate piping 364, 366. The penetrating element may be further configured to other linkages associated with heat exchanger operations (i.e., electrical wires). The penetrating element 370 may include any number of coupling components including but not limited to flanges, valves, bolts, seals, pipes, tubes, or other coupling means. In several examples, penetrating element 370 is operable to accommodate piping 364, 366 while maintaining an airtight, liquid tight, and/or hermetic seal.

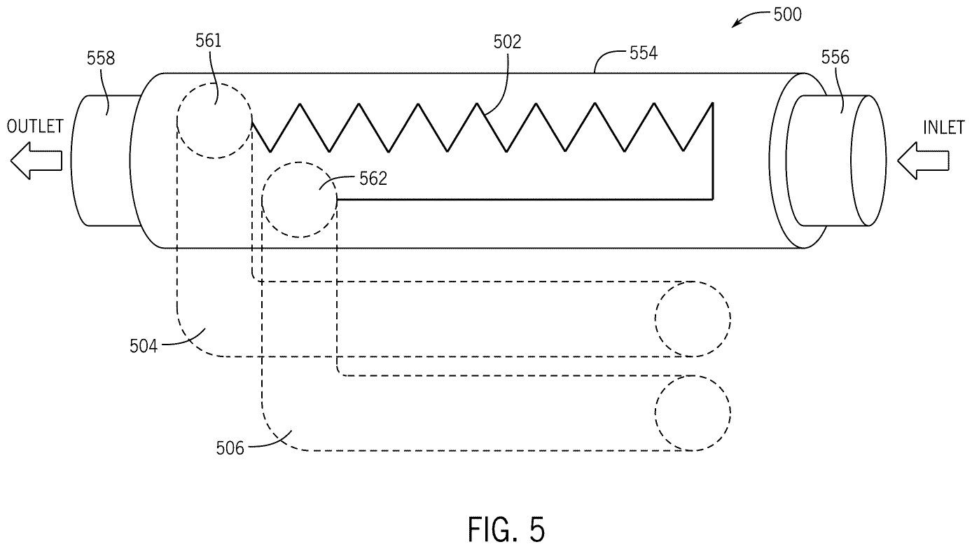

FIG. 5 illustrates a transparent view of an example gas-to-gas heat exchanger 500. The example gas-to-gas heat exchanger 500 of FIG. 5 may be substantially analogous to the various heat exchangers disclosed herein (i.e., 352a, 352b, 202a, 202b) and includes a body 554, an inlet fan 556, an outlet fan 558, a coolant inlet 561, and a coolant outlet 562. However, FIG. 5 illustrates a transparent view of heat exchanger 500, such that the cooling coil 502 is visible. FIG. 5 further illustrates a coolant inlet pipe 504 and a coolant outlet pipe 506. The inlet fan 556 and outlet fan 558 are cooperatively operable to circulate a gas through the body 554. The cooling coil 502 may be disposed within the body 554 and may be of a generally coil configuration such that as gas is circulated through the body 554, the cooling coil 502 is bathed in such a gas, wherein heat transfer occurs. The cooling coil 502 may contain a coolant therein fluidly coupled to an external heat exchanger (e.g., the liquid-to-gas heat exchanger 222 of FIG. 2) operable to cool the coolant. In several embodiments, the coolant of the cooling coil 502 is nitrogen, such that any leaks do not disrupt the functions of the MSR system.

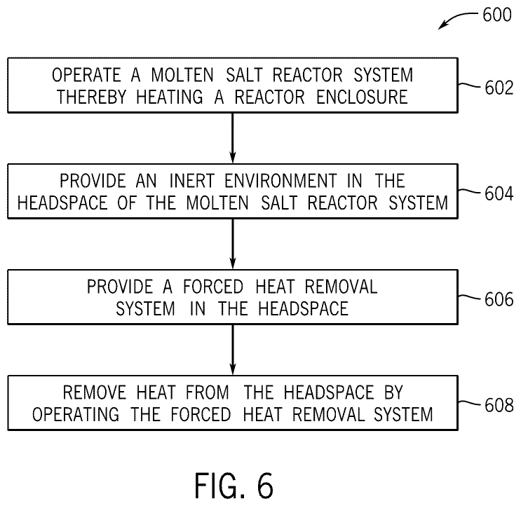

FIG. 6 illustrates a flow diagram of an example method 600 for maintaining a temperature of a headspace of a molten salt reactor system. At step 602, a molten salt reactor system is operated thereby heating a reactor enclosure. As illustrated in FIGS. 1, 2, and 3, the molten salt reactor system includes various components collectively operable to facilitate fission reaction thereby producing heat and consequently power. For example, the MSR system 100 may include a reactor vessel 102, 330 containing a reactor core 312, 234 operable to facilitate fission reaction of fissile material within a molten salt (e.g., LiF—BeF₂—UF₄). The reactor core 312, 234 may be fluidly connected to a primary heat exchanger 106, 238, 318 where heat is exchanged. As previously discussed, in order for the MSR system 100 to operate, the fuel salt must be at a sufficient temperature to maintain a molten phase, such heating may be maintained by MSR configuration of the reactor space 310 of FIG. 3. Consequently, heat is likely to rise and increase the temperature of a headspace 250 of the reactor enclosure 300.

At step 604, an inert environment is provided to the headspace of the molten salt reactor system. For example, headspace 212, 350 may be filled with an inert gas at below atmospheric pressure. In several embodiments, the inert gas is nitrogen gas; however, headspace 212, 350 may be filled with any other suitable inert gas. Advantageously, by providing an inert gas environment under atmospheric pressure (i.e., under vacuum) to headspace 212, 350 any potential leaks may be detected as air will be sucked into headspace 212, 350 and gaseous fission products may be prevented from escaping headspace 212, 350. In some embodiments, one of the temperature sensitive equipment 214, 360a, 360b, 360c, may be a sensor configured to detect any such leaks.

At step 606, a forced convection heat removal system is provided in the headspace. As previously discussed in reference to step 602, the headspace is likely to be heated by rising heat from the reactor space and in order to maintain a proper temperature range for the temperature sensitive equipment heat must be forcibly removed. In several embodiments, the forced convection heat removal system includes at least one gas-to-gas heat exchanger positioned within the headspace and coupled, by a chiller loop, to a liquid-to-gas heat exchanger positioned outside the MSR system. In these embodiments, the gas-to-gas heat exchanger is operable to cool the inert environment of the headspace by circulating the inert gas therethrough. For example, the gas-to-gas heat exchanger may include two nitrogen-to-nitrogen heat exchangers 252a, 252b, 202a, 202b coupled to a liquid-to-gas heat exchanger 220 positioned outside the reactor enclosure 210 via a chiller loop 222.

At step 608, heat is removed from the headspace by operating a forced convection heat removal system. For example, the force heat removal system 200 of FIG. 2 may be employed and the nitrogen-to-nitrogen heat exchangers 252a, 252b, 202a, 202b may be operable to circulate a nitrogen gas of the headspace, thereby cooling it and transfer heat to a nitrogen gas of a cooling coil 206a, 206b, 502. The nitrogen gas of the cooling coil 206a, 206b, 502 may then be subsequently cooled by the liquid-to-gas heat exchanger 220 by transferring heat to a liquid coolant (e.g., water) of the liquid-to-gas heat exchanger 220. Then, the liquid coolant is further cooled by a chiller 224, powered by chiller pump 226, where the heat is released to the atmosphere. Thus, the temperature of the headspace is maintained by forcibly removing heat therein via at least one gas-to-gas heat exchanger provided within the headspace coupled to a liquid-to-gas heat exchanger further coupled to a chiller both provided outside the reactor enclosure. Thus, a plurality of temperature sensitive equipment may be enabled to operate within the headspace without overheating or otherwise working inefficiently due to increased temperature. Advantageously, such temperature sensitive equipment are enabled to operate despite the headspace (and consequently the temperature sensitive equipment) being proximal to the reactor space of the reactor enclosure.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A system comprising:
a system enclosure comprising a headspace and a reactor space;
a molten salt reactor vessel including a reactor core configured to facilitate fission reaction disposed within the reactor space;
a thermal insulation layer arranged about the molten salt reactor vessel and separating the reactor space from the headspace, wherein the thermal insulation layer is operable to maintain a temperature of the molten salt reactor vessel;
a plurality of temperature sensitive equipment disposed within the headspace and including at least one functional component extending into the reactor space, the at least one functional component operably coupled with the molten salt reactor vessel;
a forced convection heat removal system configured to remove heat from the headspace thereby reducing a temperature of the headspace proximal to the plurality of temperature sensitive equipment, wherein the forced convection heat removal system includes at least one nitrogen-to-nitrogen heat exchanger configured to cool an environment within the headspace by circulating a gas through the at least one nitrogen-to-nitrogen heat exchanger.

2. The system of claim 1, wherein the reactor enclosure includes a radiation shielding layer surrounding the thermal insulation layer surrounding the reactor vessel surrounding the reactor core.

3. The system of claim 1, wherein the headspace is filled with an inert gas at below atmospheric pressure.

4. The system of claim 3, wherein the inert gas is nitrogen gas and wherein the at least one nitrogen-to-nitrogen heat exchanger includes a cooling coil filled with nitrogen gas.

5. The system of claim 1, wherein the plurality of temperature sensitive equipment includes at least one sensor connected to at least one probe, wherein the at least one sensor is disposed within the headspace and the at least one probe is disposed within the reactor space.

6. The system of claim 5, wherein the headspace includes at least one penetrating component operable to functionally link the at least one probe to the at least one sensor.

7. The system of claim 1, wherein the plurality of temperature sensitive equipment comprises equipment rated for a temperature lower than a temperature of the reactor space.

8. The system of claim 1, wherein the system enclosure further comprises a reactor access vessel, a drain tank, a pump, and a primary heat exchanger.

9. The system of claim 8, wherein the system enclosure further comprises a molten salt loop operable to continuously circulate a molten fuel salt through the reactor access vessel, the reactor core, and the primary heat exchanger, wherein the molten salt loop is circulated by the pump.

10. The system of claim 9, wherein the temperature sensitive equipment includes the pump, wherein the primary heat exchanger is disposed within the reactor space, and wherein the pump is functionally coupled to the primary heat exchanger by at least one penetrating component.

11. The system of claim 7, wherein the temperature of the reactor space is about 600° C.

12. The system of claim 2, wherein the thermal insulation layer defines a thermal insulation region operable to maintain a temperature sufficient to melt a fuel salt.

13. A forced convection heat removal system coupled to a molten salt reactor enclosure comprising:
at least one gas-to-gas heat exchanger positioned within a headspace of the reactor enclosure;
wherein the at least one gas-to-gas heat exchanger includes at least one fan, and a cooling coil configured to circulate a nitrogen gas of the headspace through the heat exchanger thereby cooling the nitrogen gas of the headspace;
wherein the cooling coil includes nitrogen gas;
a liquid-to-gas heat exchanger positioned outside the reactor enclosure;
wherein the liquid-to-gas heat exchanger is configured to cool the nitrogen gas of the cooling coil;
a chiller loop coupling the at least one gas-to-gas heat exchanger to the liquid-to-gas heat exchanger thereby facilitating removal of heat from the headspace.

14. The forced convection heat removal system of claim 13, wherein the reactor enclosure further comprises a reactor space positioned below the headspace.

15. The forced convection heat removal system of claim 14, wherein the reactor enclosure comprises a radiation shielding layer surrounding a thermal insulation layer surrounding a reactor vessel.

16. The forced convection heat removal system of claim 15, wherein the thermal insulation layer separates the reactor space from the headspace.

17. The forced convection heat removal system of claim 16, wherein a plurality of temperature sensitive equipment is disposed within the headspace and includes at least one functional component extending into the reactor space, the at least one functional component operably coupled with the reactor vessel.

18. The forced convection heat removal system of claim 13, wherein the headspace includes the nitrogen gas under partial vacuum.

19. The forced convection heat removal system of claim 13, further comprising two gas-to-gas heat exchangers.

20. The forced convection heat removal system of claim 19, wherein the two gas-to-gas heat exchangers are operable to remove about 0.00341 MMBTU/hr from the headspace.

21. The forced convection heat removal system of claim 17, wherein the reactor vessel houses a reactor core, a molten salt loop, and a primary heat exchanger collectively operable to facilitate power generation through fission reaction within the reactor core.

22. A method of maintaining a temperature of a headspace of a molten salt reactor system comprising:
operating the molten salt reactor system thereby heating a reactor enclosure;
providing an inert environment in the headspace of the reactor enclosure;
providing a forced convection heat removal system in the headspace of the reactor enclosure; and
the forced convection heat removal system comprising at least one gas-to-gas heat exchanger positioned within the headspace and coupled, by a chiller loop, to a liquid-to-gas heat exchanger positioned outside the molten salt reactor system;
the at least one gas-to-gas heat exchanger configured to remove heat from the headspace by transferring the heat to the liquid-to-gas heat exchanger;
removing heat from the headspace by operating the forced convection heat removal system.

23. The method of claim 22, further comprising operating a plurality of temperature sensitive equipment in the headspace of the reactor enclosure.
